(19) United States
(12) Patent Application Publication
(10) Pub. No.: US 2020/0183120 A1
(43) Pub. Date: Jun. 11, 2020

(54) SMARTPHONE LENS FILTER CASE

(71) Applicant: David Graham Clark, Lakewood, CO (US)

(72) Inventor: David Graham Clark, Lakewood, CO (US)

(73) Assignee: New Ideas Manufacturing, LLC, Englewood, CO (US)

(21) Appl. No.: 16/748,591

(22) Filed: Jan. 21, 2020

Related U.S. Application Data
(60) Provisional application No. 62/777,710, filed on Dec. 10, 2018.

(51) Int. Cl. G02B 7/00; G02B 27/28; A45C 11/00

(52) U.S. Cl. CPC G02B 7/006; A45C 2011/002; A45C 11/00; G02B 27/288

(57) ABSTRACT

A smartphone lens filter case is provided enabling a user to improve their smartphone photography by providing various lens filters configured to be integrated with the filter case. The case includes a protective body configured to protect a smartphone having at least one camera lens. At least one opening on the protective body is provided, wherein the opening exposes the at least one camera lens of the smartphone. At least one filter cartridge adapted to be received by the case. A plurality of lens filters on the at least one filter cartridge are provided, the plurality of lens filters configured to be positioned over the at least one camera lens of the smartphone.

### CROSS-REFERENCE TO RELATED APPLICATIONS

The present application claims priority to U.S. Patent Application Ser. No. 62/777,710, filed on Dec. 10, 2018, the disclosure of which is hereby incorporated in its entirety at least by reference.

### BACKGROUND OF THE INVENTION

### 1. Field of the Invention

The present invention relates generally to lens filters, but more particularly to a smart phone filter case configured to add a plurality of filters to one or more smartphone cameras.

### 2. Description of Related Art

Most photography filters used with smartphones are during post processing, after a photo is taken. Further, existing lens filters for smartphones are bulky accessories that are not practical to carry for everyday use. Consequently, there is a need for a more efficient design to provide one or more lens filters for a smartphone camera.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a smartphone lens filter case is provided, comprising a protective body configured to protect a smartphone having at least one camera lens; at least one opening on the protective body, wherein the opening exposes the at least one camera lens of the smartphone; at least one filter cartridge adapted to be received by the case; a plurality of lens filters on the at least one filter cartridge, the plurality of lens filters configured to be positioned over the at least one camera lens of the smartphone.

In one embodiment, the at least one filter cartridge is configured to be slid into various positions. In one embodiment, the various positions include at least three positons defined as a first position wherein a first lens filter of the plurality of lens filters is covering the at least one camera, a second position wherein a second lens filter of the plurality of lens filters is covering the at least one camera, and a third positon wherein the plurality of lens filters is not covering the at least one opening and/or the at least one camera. In one embodiment, the at least one filter cartridge includes a thumb guide configured to aid the user when positioning the at least one filter cartridge. In one embodiment, the plurality of lens filters are selected from the group essentially consisting of a neutral density filter, graduated neutral density filter, color filters, polarizer filter, UV/clear/haze filters, close-up filter, and a special effects filter.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. it should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective rear view of a smartphone lens filter case according to an embodiment of the present invention.

FIG. 2 is a perspective rear view thereof showing the lens filter removed from the smartphone case.

FIG. 3 is a front perspective view thereof showing the lens filter removed from the smartphone case.

FIG. 4 is a perspective rear view thereof showing the lens filter in a first position according to an embodiment of the present invention.

FIG. 5 is a perspective rear view thereof showing the lens filter in a second position according to an embodiment of the present invention.

FIG. 6 is a perspective rear view of an alternative smartphone lens filter case according to an embodiment of the present invention.

FIG. 7 is a rear view of an alternative smartphone lens filter case according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a smartphone lens filter case.

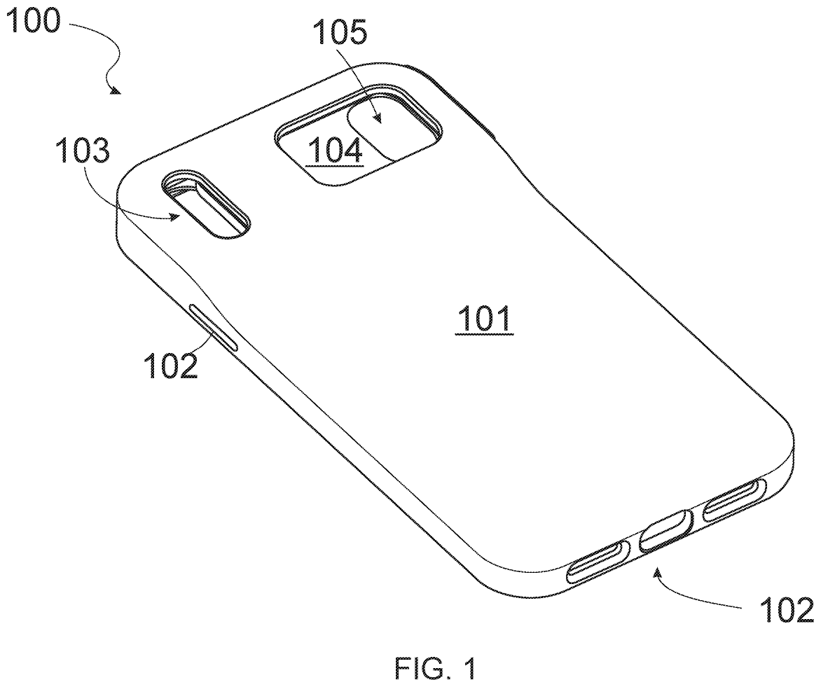

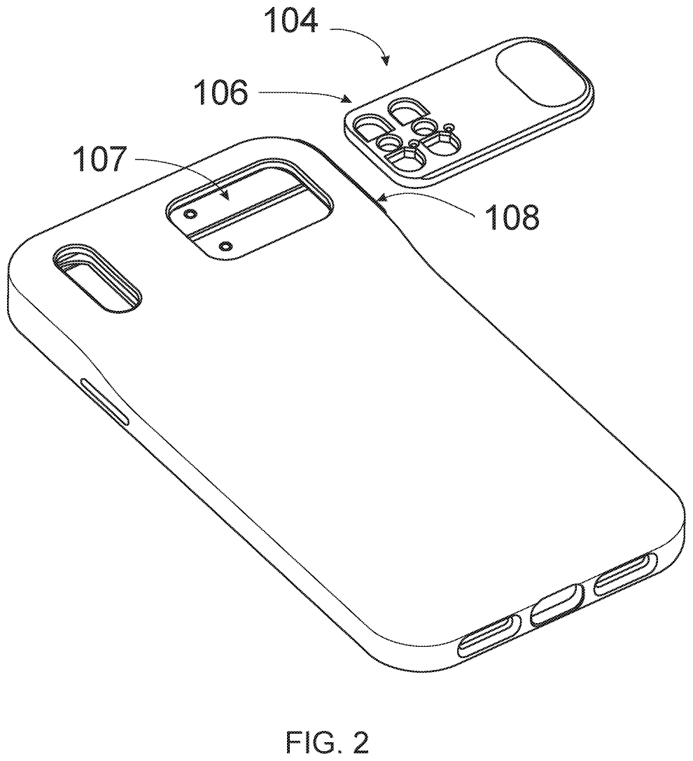

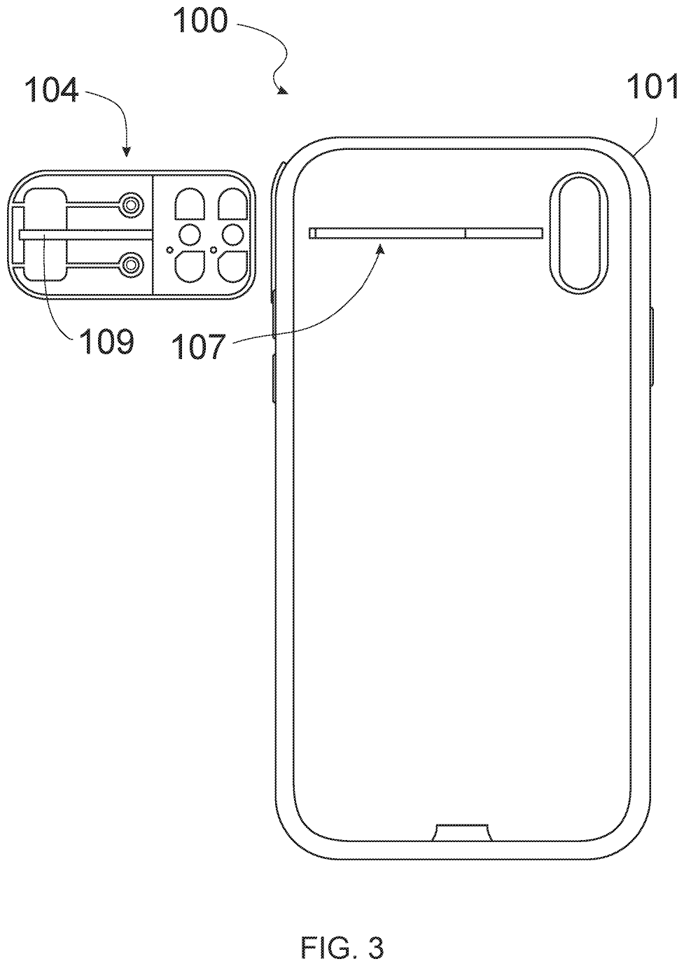

Referring now to FIGS. 1-3, a smartphone lens filter case 100 is illustrated. In one embodiment, the case comprises a protective body 101 designed to protect a smartphone (not illustrated) as well known in the art. The case is sized and shaped to accommodate various smartphone models and products. Similar to most smartphone cases, the case is configured to wrap around the sides and back of the smartphone while leaving the front of the smartphone exposed for use. The case includes accessory/button openings 102 enabling the user to access various ports and controls for the smartphone during use without the need to remove the case. The case is constructed from any material known in the art and may be rigid, flexible, or a combination thereof. It should be understood that the case itself is not the inventive concept, and is simply a means to provide a lens filter to a smartphone camera in best possible way. Thus, the case can be of any design, shape, material, etc. without departing from the scope and spirit of the invention. However, a few requirements of the case are required. First, the case must include an opening 103, wherein the opening exposes the camera lens or lenses of the smartphone. The design and shape shown for opening 103 is for an Apple® iPhone® X, but the opening can be modified for any smartphone. For instance, the oval shape illustrated is sized to expose the two cameras positioned on the rear of the iPhone X smartphone. Further, as new smartphones, such as Apple® iPhone®, are release every year and the camera positions on the rear portion of the smartphone may vary, it should be understood that the position, size, and the number of openings may vary. Similarly, if another smartphone product or model is used this opening will be modified to expose all the smartphone's cameras. Thus, the opening may be a circle shape, oval shape, triangular, square shape, rectangular shape, or an irregular shape. Further, in some embodiments, more than one opening may be provided.

The main objective of the invention is to provide a filter cartridge 104 that includes a plurality of lens filters 106, wherein each lens filter of the plurality of lens filters may be any lens filter known in the art, including but not limited to neutral density, graduated neutral density, color filters, polarizers, UV/clear/haze filters, close-up filter, special effects filter, etc.

The filter cartridge's design is such that the filter cartridge may be slid, moved, or adjusted such that one or more of the plurality of lens filters are adapted to cover one or more the smartphone cameras. The arrangement of the plurality of filters may be horizontal, vertical, irregular, etc. typically corresponding to the orientation of the smartphone cameras. In one embodiment, the filter cartridge is slid in a horizontal plan via track 107. In one embodiment, a protrusion 109 on the back of the filter cartridge is adapted to slide in the track. An opening 108 allows the filter cartridge to be slid out of the case completely, for removing the cartridge for service, cleaning, etc. or to replace the cartridge with a different type of filter cartridge having a different type of filter. It should be understood, that this is just one example and other designs may be implemented. For instance, the filter cartridge may be slid vertically from underneath the camera as opposed to horizontally in line with the camera. In other embodiments, the filter cartridge can be rotated into position. Yet in other embodiments, a combination of rotation and horizontal and/or vertical movement may be utilized. Thus, any arrangement is possible as the spirit of the invention is to provide a sleek, easy to use lens filter design that a user can leave on the smartphone when not in use. For instance, the case as described will still allow for the transportation of the smartphone in the user's pocket. This is much improved compared with the bulky designs of the prior art.

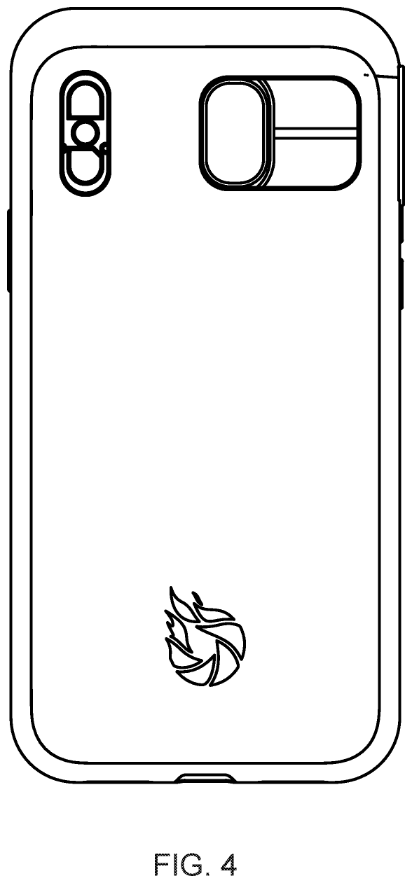

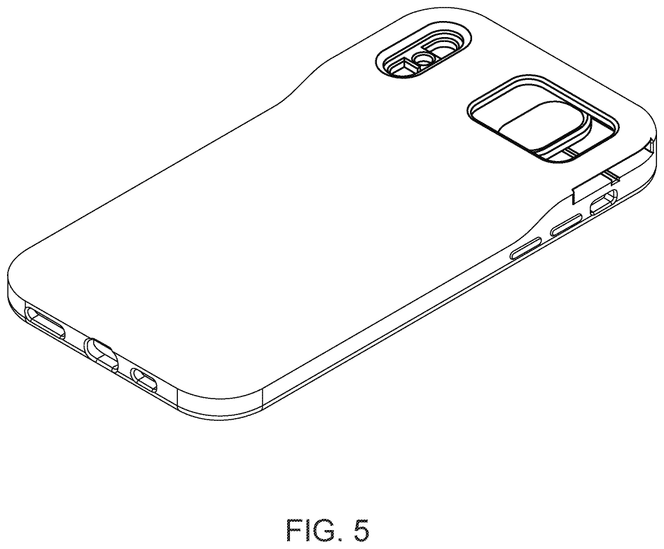

Advantageously, the filter cartridge may be slid into various positions, including but not limited to, in the case but not covering the camera opening 103, removed from the case, and in the case covering the camera with one or more of the plurality of lens filters. For instance, in the example illustrated there are two vertical columns of filters giving the user two possible positions when the filter cartridge and plurality of lens filters are in use (shown in FIGS. 4 and 5). However, as previously mentioned, there may be any number of arrangements of the plurality of lens filters enabling the user to have more positional options.

Advantageously, the various positions enable a user to select multiple filter orientations. For instance, the plurality the lens filters may be orientated in multiple columns, wherein each column contains at least one polarizer filter prepositioned, such as vertical in one column and horizontal in another column. The user can simply move the filter cartridge to any of the various positions (one column or the other column covering the smartphone's camera lens) to change the polarization. Typically, polarizer filters of the prior must be rotated to change the polarization. Further, for filters polarizer of the prior art configured for use in conjunction with a smartphone, it is difficult to know if the polarizer is lined up correctly. Consequently, the slide motion provides a distinct advantage of the rotation motion of the prior art, eliminating the guesswork required with lining up a polarizer filter of the prior art.

The plurality of lens filers on the filter cartridge may be arranged in any shape, orientation, or number. In one embodiment, a thumb guide 105 is provided to aid the user when sliding the filter cartridge. This thumb guide simply gives the user a frictional surface when used with a thumb to help slide the filter cartridge via track 107. It should be understood that any user aid may be provide to facilitate the movement of the filter cartridge, including but not limited to a knob, protrusion, or automatic/electrical motorized movement, etc.

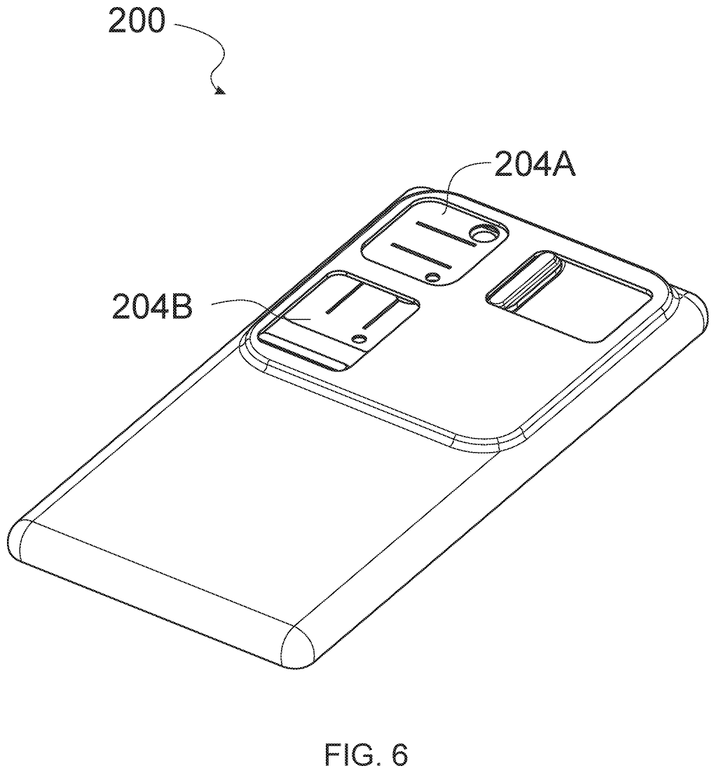

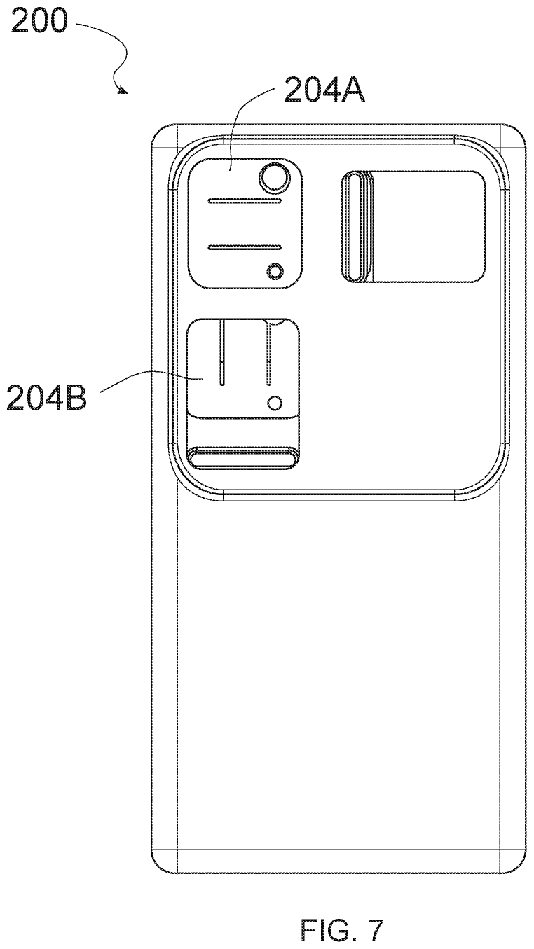

FIGS. 6-7 show various views of an alternative smartphone lens filter case 200 according to an embodiment of the present invention. Referring now to FIGS. 6-7, the alternative smartphone lens filter case is an exemplary example of an alternative design featuring two filter cartridges 204A and 204B in the horizontal and vertical orientation respectively. This specific design may be provided for a variety of smart phone models, but is optimized for the Apple Apple® iPhone® 11. Each of the lens filters may be any lens filter known in the art, including but not limited to neutral density, graduated neutral density, color filters, polarizers, UV/clear/haze filters, close-up filter, special effects filter, dark CPL filters, Night Sky filters, etc. The duel orientation offers multiple filter options and arrangements for covering the smart phone's many rear cameras (not shown), Advantageously, the various positions enable a user to select multiple filter orientations, such as the polarizer example previously discussed. Similarly, the two filter cartridges offers even more possibilities for various filter options depending on what position each of the filter cartridges are positioned to.

Although the invention has been described in considerable detail in language specific to structural features, itis to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A smartphone lens filter case:
a protective body configured to protect a smartphone having at least one camera lens;
at least one opening on the protective body, wherein the opening exposes the at least one camera lens of the smartphone;
at least one filter cartridge adapted to be received by the case;
a plurality of lens filters on the at least one filter cartridge, the plurality of lens filters configured to be positioned over the at least one camera lens of the smartphone.

2. The smartphone lens filter case of claim 1, wherein the at least one filter cartridge is configured to be slid into various positions.

3. The smartphone lens filter case of claim 2, wherein the various positions include at least three positons defined as a first position wherein a first lens filter of the plurality of lens filters is covering the at least one camera, a second position wherein a second lens filter of the plurality of lens filters is covering the at least one camera, and a third positon wherein the plurality of lens filters is not covering the at least one opening and/or the at least one camera.

4. The smartphone lens filter case of claim I, wherein the at least one filter cartridge includes a thumb guide configured to aid a user when positioning the at least one filter cartridge.

5. The smartphone lens filter case of claim 1, the plurality of lens filters are selected from the group essentially consisting of a neutral density filter, graduated neutral density filter, color filters, polarizer filter, UV/clear/haze filters, close-up filter, a special effects filter, a dark CPL filter, and a night sky filter.

6. A smartphone lens filter case:
a protective body configured to protect a smartphone having at least one camera lens;
at least one opening on the protective body, wherein the opening exposes the at least one camera lens of the smartphone;
at least one filter cartridge adapted to be received by the case;
a plurality of lens filters on the at least one filter cartridge, the plurality of lens filters configured to be positioned over the at least one camera lens of the smartphone, wherein the plural of lens filters are arranged in rows and/or columns.

7. The smartphone lens filter case of claim 6, wherein the at least one filter cartridge is configured to be slid into various positions.

8. The smartphone lens filter case of claim 7, wherein the various positions include at least three positons defined as a first position wherein a first lens filter of the plurality of lens filters is covering the at least one camera, a second position wherein a second lens filter of the plurality of lens filters is covering the at least one camera, and a third positon wherein the plurality of lens filters is not covering the at least one opening and/or the at least one camera.

9. The smartphone lens filter case of claim 8, wherein the first lens filter and the second lens filter of the plurality of lens filters is a first polarizer filter in a first position and a second polarizer filter in a second position.

10. The smartphone lens filter case of claim 9, wherein the first and second polarizer filters enable a user to select a desired polarization effect without the need to rotate either the first or second polarizer filter.
